(19) United States
(12) Patent Application Publication
(10) Pub. No.: US 2014/0211395 A1
(43) Pub. Date: Jul. 31, 2014

(54) ELECTRONIC DEVICE WITH DETACHABLE KEYBOARD

(71) Applicant: HON HAI PRECISION INDUSTRY CO., LTD., New Taipei (TW)

(72) Inventors: TAY-YANG LIN, New Taipei (TW); CHIN-FENG CHEN, New Taipei (TW); CHIA-JUNG LIU, New Taipei (TW); SHU-MING LIU, New Taipei (TW)

(73) Assignee: HON HAI PRECISION INDUSTRY CO., LTD., New Taipei (TW)

(21) Appl. No.: 14/160,560

(22) Filed: Jan. 22, 2014

(30) Foreign Application Priority Data
Jan. 30, 2013 (TW) 102103599

(51) Int. Cl. G06F 1/16

(52) U.S. Cl. CPC G06F 1/1669
USPC 361/679.17

(57) ABSTRACT

An electronic device includes a base and a keyboard module. The base defines a receiving space in which a number of magnets is received. The keyboard module includes a first side and a second side opposite to the first side. A frame is connected between sidewalls of the first side and the second side. The first side includes a key unit. The second side includes a screen. The keyboard module includes a number of mounting members made of magnetic material. The keyboard module is received in the receiving space in either a first position to expose the key unit to the first surface, or a second position to expose the screen to the first surface. The magnets are configured to adhere to the number of mounting members to secure the keyboard module in the receiving space.

### FIELD

The disclosure generally relates to electronic devices, and more particularly to an electronic device having a detachable keyboard.

### BACKGROUND

Electronic devices, such as notebook computers, are widely used. The notebook computers are often equipped with keyboards for inputting information. However, the keyboard is usually fixed to the notebook computer and cannot be removed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device having a detachable keyboard module.

FIG. 2 is similar to FIG. 1, but viewed from another direction.

FIG. 3 is an assembled view of the electronic device of FIG. 1, which shows the keyboard of the electronic device in a first position.

FIG. 4 is another assembled view of the electronic device of FIG. 1, which shows the keyboard of the electronic device in a second position.

FIG. 5 is an exploded, isometric view of another embodiment of an electronic device having a detachable keyboard module.

FIG. 6 is an exploded, isometric view of another embodiment of an electronic device having a detachable keyboard module.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

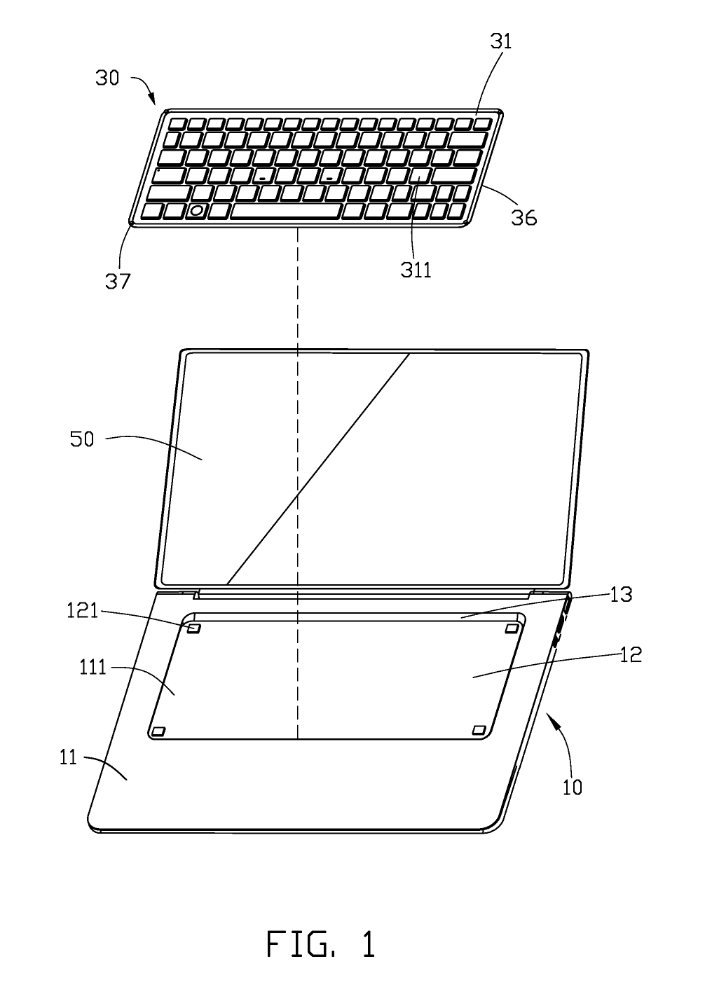

FIG. 1 shows one embodiment of an electronic device. The electronic device includes a base 10, a keyboard module 30, and a cover 50. The cover 50 is pivotably mounted to the base 10. The keyboard module 30 is detachably mountable on the base 10, and is shown in a position detached from the base 10. The keyboard module 30 can be electronically coupled to the base 10 for wireless data transmission. For example, the wireless data transmission coveys data using WIFI transmission or infrared optical transmission.

The base 10 includes an operation surface 11. The operation surface 11 defines a receiving space 111 adjacent to the cover 50 for receiving the keyboard module 30 therein. In one embodiment, a depth of the receiving space 111 is substantially equal to a thickness of the keyboard module 30. The receiving space 111 includes a bottom 12 and a plurality of sidewalls 13. The plurality of sidewalls 13 cooperatively bound the receiving space 111. Each corner of the bottom 12 has a magnet 121. In the illustrated embodiment, there are four magnets 121 located in four respective corners of the bottom 12.

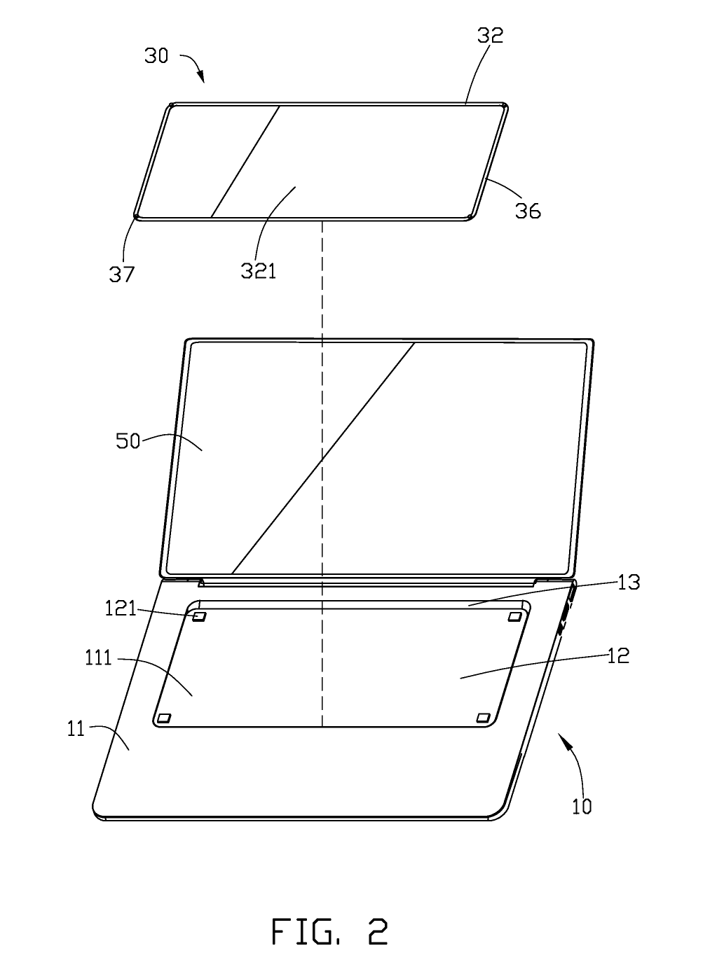

Referring to FIGS. 1 and 2, the keyboard 30 includes a first side 31(which is a top side of the keyboard module 30 in the embodiment) and a second side 32 (which is a bottom side of the keyboard module 30 in the embodiment) opposite from the first side 31. The first side 31 is substantially parallel to the second side 32. The first side 31 includes a key unit 311, which includes a plurality of keys. The second side 32 includes a screen 321. In one embodiment, the screen 321 is a touch screen. The keyboard module 30 includes a frame 36 connected between sidewalls of the first side 31 and the second side 32. Each corner of the first side 31 and of the second side 32 has a mounting member 37, which is made of magnetic material.

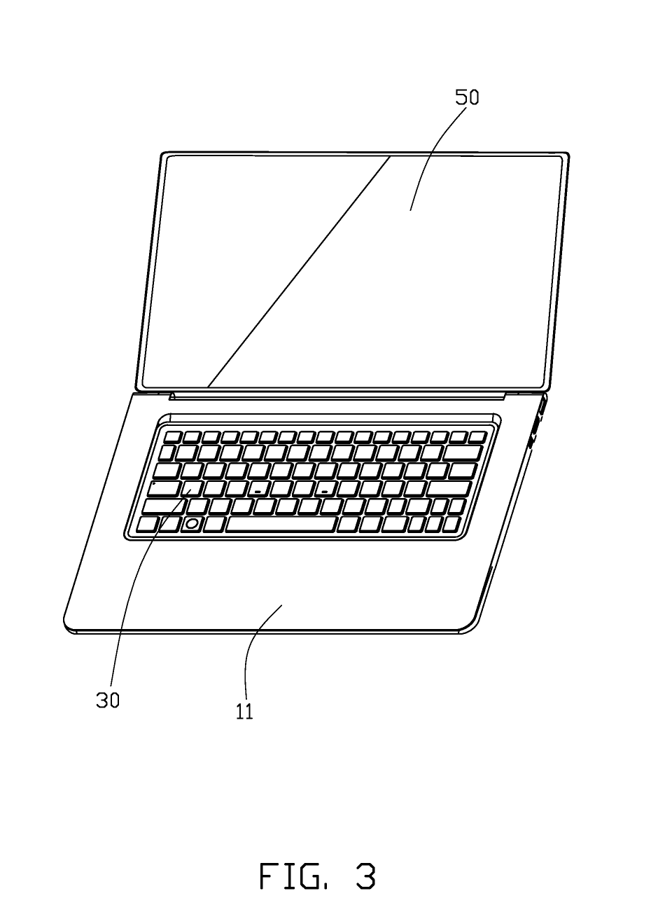

Referring to FIGS. 1 and 3, to mount the keyboard module 30 in a first direction, the first side 31 of the keyboard module 30 is located above the second side 32 (shown in FIG. 2). The keyboard module 30 is received in the receiving space 111 of the base 10, such that the key unit 311 is exposed to the operation surface 11. The magnets 121 of the base 10 adhere to the mounting members 37 of the second side 32 of the keyboard module 30. Thus, the keyboard module 30 is securely received in the receiving space 111.

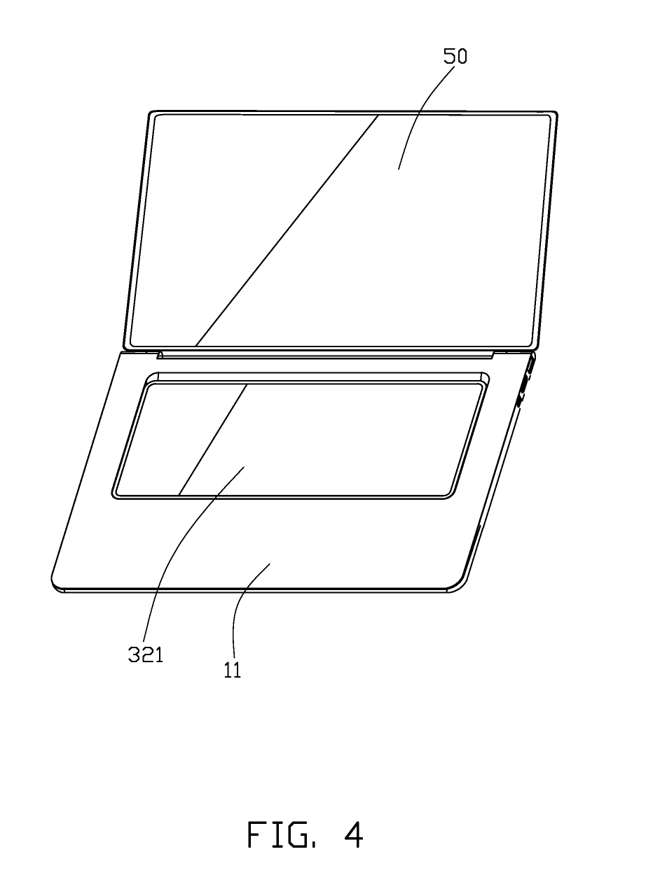

Referring to FIGS. 2 and 4, to mount the keyboard module 30 in a second direction, the second side 32 of the keyboard module 30 is located above the first side 31 (in FIG. 1). The keyboard module 30 is received in the receiving space 111 of the base 10, such that the screen 321 is exposed to the operation surface 11. The magnets 121 of the base 10 adhere to the mounting members 37 of the first side 31 of the keyboard module 30. Thus, the keyboard module 30 is securely received in the receiving space 111.

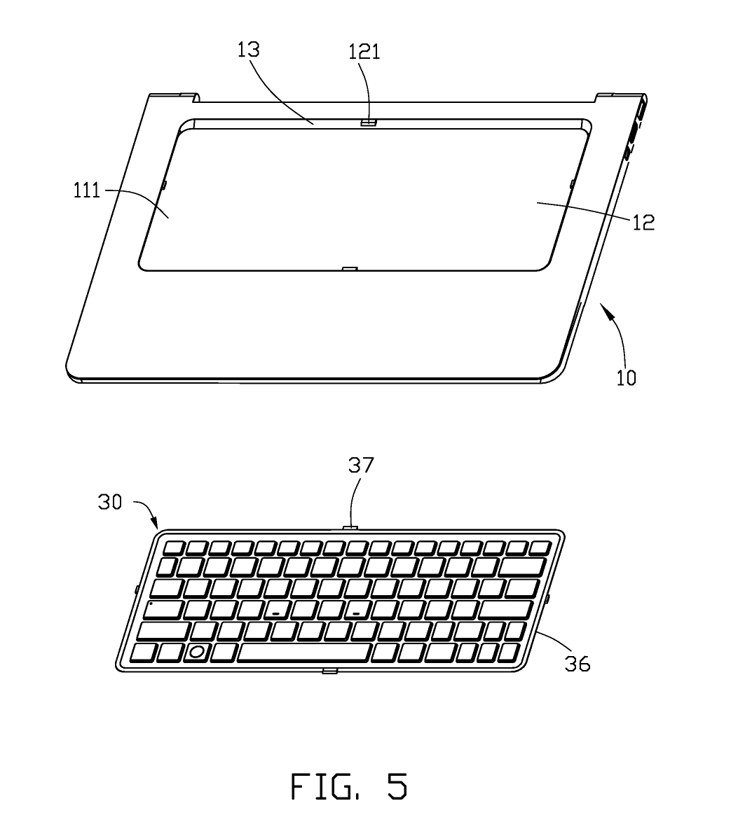

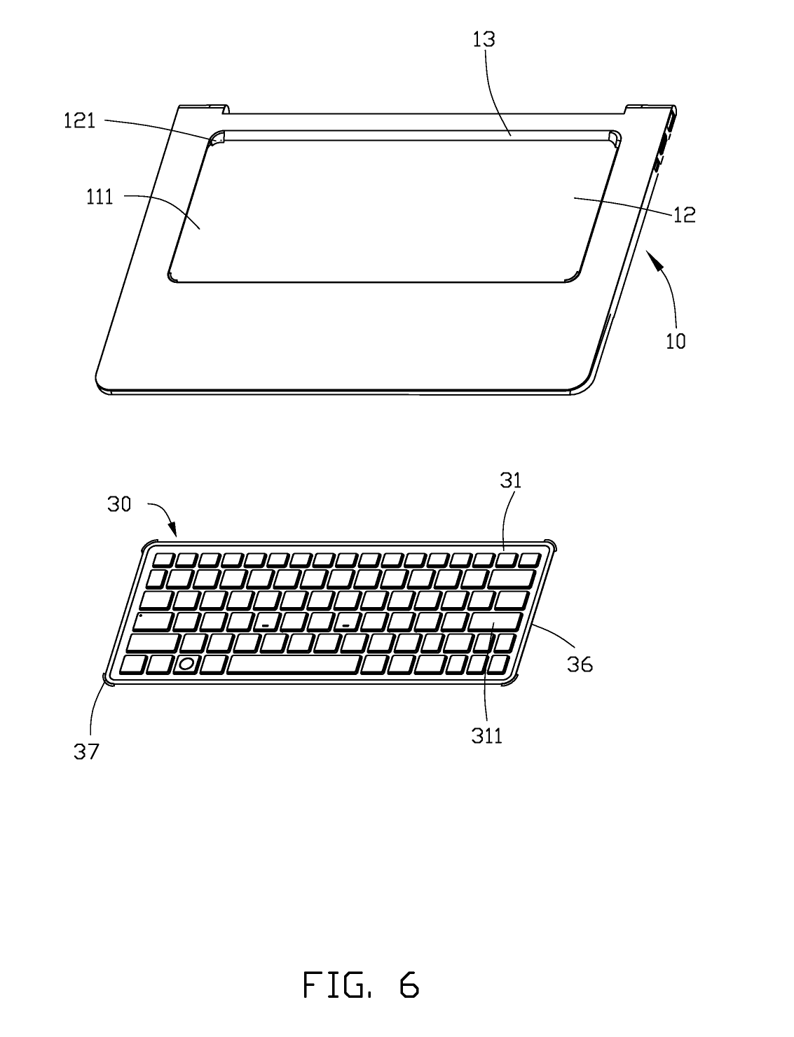

Referring to FIG. 5, in another embodiment, the magnets 121 are located on the sidewalls 13 of the receiving space 111, and the mounting members 37 are mounted on the frame 36 of the keyboard module 30, such that the mounting members 37 spatially correspond to the magnets 121. Referring to FIG. 6, the magnets 121 are located in corners of the sidewalls 13, and the mounting members 37 are mounted on corners of the frame 36.

Alternatively, the plurality of magnets 121 can be set on the keyboard module 30, and the plurality of mounting members 37 can be located in the base 10.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a base defining a receiving space, a plurality of magnets located in the receiving space; and
a keyboard module comprising a first side and a second side opposite to the first side, a frame connected between sidewalls of the first side and the second side, the first side comprising a key unit, the second side comprising a screen, the keyboard module comprising a plurality of mounting members which are made of magnetic material;
wherein the keyboard module is configured to be located in the receiving space in different directions to expose either the key unit or the screen, and the plurality of magnets is configured to adhere to the plurality of mounting members to secure the keyboard module in the receiving space.

2. The electronic device of claim 1, wherein the base comprises an operation surface, and the operation surface is sunk to form the receiving space.

3. The electronic device of claim 2, wherein the plurality of magnets is mounted on corners of a bottom of the receiving space.

4. The electronic device of claim 2, wherein the base comprises a plurality of sidewalls surrounding the receiving space, and the plurality of magnets is secured on corners of the sidewalls.

5. The electronic device of claim 2, wherein the base comprises a plurality of sidewalls surrounding the receiving space, and the plurality of magnet is secured on the plurality of sidewalls.

6. The electronic device of claim 1, wherein the screen is a touch screen.

7. The electronic device of claim 1, wherein the key unit comprises a plurality of keys.

8. An electronic device, comprising:
a base comprising a plurality of magnets; and
a keyboard module detachably mountable on the base, the keyboard module comprising a plurality of mounting members which are made of magnetic material, a screen mounted on a bottom side of the keyboard module;
wherein the keyboard module is configured to be mounted on the base with the screen exposed on the base, and the plurality of magnets is configured to adhere to the plurality of mounting members to secure the keyboard module on the base.

9. The electronic device of claim 8, wherein the keyboard module comprises a frame surrounding the keyboard module, the plurality of mounting members is mounted on the frame; the base is sunk to define a receiving space, the base comprises a plurality of sidewalls surrounding the receiving space, and the plurality of magnets is mounted on the plurality of sidewalls.

10. The electronic device of claim 8, wherein the base is sunk to define a receiving space, and the plurality of magnets is mounted on a bottom of the receiving space, the keyboard module comprises a top side opposite to the bottom side of the keyboard module, and the plurality of mounting members is secured on the top side and the bottom side of the keyboard module.

11. The electronic device of claim 10, wherein the plurality of magnets is mounted on corners of the bottom of the receiving space, and the plurality of mounting members is secured on corners of the top side and the bottom side of the keyboard module.

12. The electronic device of claim 8, wherein a key unit is mounted on the top side of the keyboard module, and the key unit comprises a plurality of keys.

13. The electronic device of claim 8, wherein the screen is a touch screen.
